(19) United States
(12) Patent Application Publication
(10) Pub. No.: US 2024/0332549 A1
(43) Pub. Date: Oct. 3, 2024

(54) POSITIVE ELECTRODE AND BATTERY

(71) Applicant: HONDA MOTOR CO., LTD., Tokyo (JP)

(72) Inventors: Kiyoshi Tanaami, Wako-shi (JP); Toshimitsu Tanaka, Wako-shi (JP)

(21) Appl. No.: 18/589,480

(22) Filed: Feb. 28, 2024

(30) Foreign Application Priority Data
Mar. 29, 2023 (CN) 202310323396.2

(51) Int. Cl. H01M 4/80; H01M 4/02

(52) U.S. Cl. CPC H01M 4/806; H01M 2004/028

(57) ABSTRACT

Disclosed is a positive electrode including: a positive electrode current collector; a positive electrode active material layer formed on the positive electrode current collector; and a current collecting portion connected to the positive electrode current collector, wherein, in the positive electrode active material layer, a region spaced apart from the current collecting portion is constituted by a composite body that includes a positive electrode mixture containing a positive electrode active material and a metal body.

### CROSS-REFERENCE TO RELATED APPLICATION

Priority is claimed on Chinese Patent Application No. 202310323396.2, filed Mar. 29, 2023, the content of which is incorporated herein by reference.

### BACKGROUND OF THE INVENTION

### Field of the Invention

The present invention relates to a positive electrode and a battery including the positive electrode.

### Description of Related Art

A positive electrode of a battery is obtained, for example, by coating a positive electrode current collector with an electrode mixture to form a positive electrode active material layer.

In a case where an aspect ratio of the positive electrode (a ratio of a length to a width of the positive electrode) is large, as a distance from the current collecting portion connected to one end surface in a length direction of the positive electrode current collector increases, variations in current distribution occur on a surface of the positive electrode in contact with a solid-state electrolyte layer. The variations in current distribution cause variations in ion conduction. The variations in ion conduction also cause variations in battery reaction. Particularly, when a large current with a high rate flows through the positive electrode or when the battery is quickly charged, the variations in battery reaction become noticeable.

As described above, when charging and discharging cycles are repeated in a battery equipped with a positive electrode with large variations in current distribution, the influence on resistance deterioration increases, the deterioration of the positive electrode is accelerated, and the battery performance becomes insufficient. Particularly, in batteries where the reaction is promoted by solid-to-solid contact, there is no flow of the solid-state electrolyte layer, and thus it is assumed that the deterioration of the positive electrode becomes more noticeable.

Furthermore, a battery electrode in which the density of a current collector varies depending on a location is known (see, for example, Patent Documents 1 and 2). In this way, the electrode including the current collector whose density varies depending on a location causes the variations in battery reaction as described above.

### PATENT DOCUMENTS

[Patent Document 1] Japanese Unexamined Patent Application, First Publication No. 2011-175934

[Patent Document 2] Japanese Unexamined Patent Application, First Publication No. 2011-154979

### SUMMARY OF THE INVENTION

As described above, a battery including a positive electrode with large variations in current distribution has a problem in that the positive electrode deteriorates noticeably.

In order to solve the above problem, an object of the present application is to suppress variations in current distribution of the positive electrode. This in turn contributes to energy efficiency.

In order to achieve the above object, the present invention provides the following embodiments.
[1] A positive electrode comprising:
   a positive electrode current collector;
   a positive electrode active material layer formed on the positive electrode current collector; and
   a current collecting portion connected to the positive electrode current collector,
   wherein, in the positive electrode active material layer, a region spaced apart from the current collecting portion is constituted by a composite body that includes a positive electrode mixture containing a positive electrode active material and a metal body.

According to the positive electrode of the present invention, in the positive electrode active material layer, the region spaced apart from the current collecting portion is constituted by the composite body that includes the positive electrode mixture containing the positive electrode active material and the metal body, and thus it is possible to suppress variations in current distribution of the positive electrode. Therefore, in a case where the positive electrode is applied to a battery, deterioration of the positive electrode can be suppressed.
[2] A positive electrode comprising:
   a positive electrode current collector;
   a positive electrode active material layer formed on the positive electrode current collector; and
   a current collecting portion connected to the positive electrode active material layer,
   wherein the positive electrode active material layer includes a composite body that includes a positive electrode mixture containing a positive electrode active material and a metal body, and is configured such that as a distance from the current collecting portion increases, a thickness of the composite body with respect to the positive electrode current collector increases.

According to the positive electrode of the present invention, the positive electrode active material layer includes the composite body that includes the positive electrode mixture containing the positive electrode active material and the metal body, and as the distance from the current collecting portion increases, the thickness of the composite body with respect to the positive electrode current collector increases, and thus the variations in current distribution of the positive electrode can be suppressed. Therefore, in a case where the positive electrode is applied to an all-solid-state battery, deterioration of the positive electrode can be suppressed.
[3] The positive electrode according to [1] or [2], wherein the metal body is a porous metal body or a metal mesh.

The metal body is a porous metal body or a metal mesh, and thus the positive electrode mixture can be held within the metal body.
[4] A battery comprising:
   the positive electrode according to claim [1] or [2];
   a negative electrode in which a negative electrode active material layer is formed on a negative electrode current collector; and
   an electrolyte layer that is disposed between the positive electrode and the negative electrode.

The battery of the present invention includes the positive electrode of the present invention, and thus deterioration of the positive electrode is suppressed and the life is extended.
[5] The battery according to [4], which is an all-solid-state battery.

The battery of the present invention is an all-solid-state battery and includes the positive electrode of the present invention, and thus deterioration is suppressed and the life is extended.
[6] A battery comprising:
   the positive electrode according to [3];
   a negative electrode in which a negative electrode active material layer is formed on a negative electrode current collector; and
   an electrolyte layer that is disposed between the positive electrode and the negative electrode.

The battery of the present invention includes the positive electrode of the present invention, and thus deterioration of the positive electrode is suppressed and the life is extended.
[7] The battery according to [6], which is an all-solid-state battery.

The battery of the present invention is an all-solid-state battery and includes the positive electrode of the present invention, and thus deterioration is suppressed and the life is extended.

According to the present invention, it is possible to suppress variations in current distribution of the positive electrode.

### BRIEF DESCRIPTION OF THE DRAWINGS

FIG. 1 shows a first embodiment of a positive electrode according to an embodiment of the present invention, and is a cross-sectional view in a length direction of the positive electrode.

FIG. 2 shows a second embodiment of the positive electrode according to the embodiment of the present invention, and is a cross-sectional view in the length direction of the positive electrode.

FIG. 3 is a plan view showing a third embodiment of the positive electrode according to the embodiment of the present invention.

FIG. 4 is a side view showing the third embodiment of the positive electrode according to the embodiment of the present invention.

FIG. 5 is a front view showing the third embodiment of the positive electrode according to the embodiment of the present invention.

FIG. 6 is a cross-sectional view showing an example of a battery according to the embodiment of the present invention.

### DETAILED DESCRIPTION OF THE INVENTION

Hereinafter, embodiments of the present invention will be described in detail with reference to the drawings.

### [Positive Electrode]

### First Embodiment

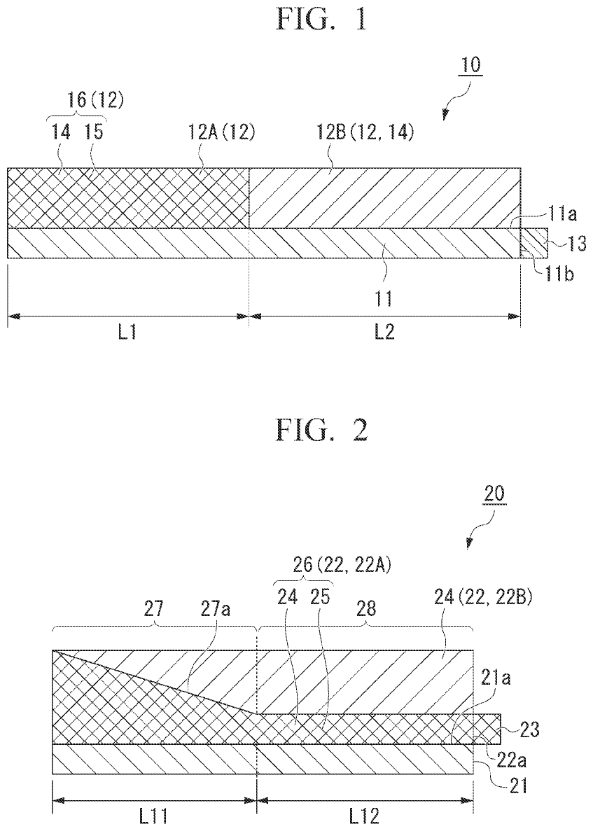

FIG. 1 shows a first embodiment of a positive electrode according to an embodiment of the present invention, and is a cross-sectional view in a length direction of the positive electrode. In the drawings used in the following description, to make characteristics easy to understand, characteristic portions may be enlarged for convenience in some cases, and the dimensional ratios and the like of the constituent elements are not limited to those illustrated.

A positive electrode 10 of the present embodiment (hereinafter sometimes abbreviated as “positive electrode”) includes a positive electrode current collector 11, a positive electrode active material layer 12 formed on one main surface 11a of the positive electrode current collector 11, and a current collecting portion (a current collecting tab) 13 connected to one end surface 11b of the positive electrode current collector 11 in a length direction.

According to the present embodiment, in the positive electrode active material layer 12, a region 12A spaced apart from the current collecting portion 13 in the length direction of the positive electrode current collector 11 is constituted by a composite body 16 that includes a positive electrode mixture 14 containing a positive electrode active material and a metal body 15. Further, in the positive electrode active material layer 12, a region 12B near the current collecting portion 13 is constituted by the positive electrode mixture 14 containing the positive electrode active material. That is, in one embodiment, the region 12B near the current collecting portion 13 is constituted by the positive electrode mixture 14 containing the positive electrode active material, but does not contain the metal body 15.

The ratio (L1/L2) of the length of the positive electrode current collector 11 in the region 12A in the length direction (L1 shown in FIG. 1) to the length of the positive electrode current collector 11 in the region 12B in the length direction (L2 shown in FIG. 1) is not particularly limited, but is preferably 30/70 to 70/30 and is more preferably 40/60 to 60/40, for example.

The positive electrode current collector 11 is preferably made of at least one highly conductive material.

Examples of the highly conductive material include materials with high conductivity, for example, metals containing at least one metallic element selected from silver (Ag), palladium (Pd), gold (Au), platinum (Pt), aluminum (Al), copper (Cu), chromium (Cr), and nickel (Ni), alloys such as stainless steel, or non-metals such as carbon (C). Aluminum, nickel, or stainless steel is preferable in consideration of manufacturing cost in addition to high conductivity. Further, aluminum is preferable because it hardly reacts with the positive electrode active material, the negative electrode active material, and the solid-state electrolyte. For this reason, when aluminum is used for the positive electrode current collector 11, the internal resistance of a battery (for example, an all-solid-state battery 100 which will be described below) can be reduced.

Examples of the shape of the positive electrode current collector 11 include any known shape such as a foil shape, a plate shape, a mesh shape, a nonwoven fabric shape, and a foam shape. Further, in order to improve the adhesion with the positive electrode active material layer 12, carbon and the like may be disposed on the surface of the positive electrode current collector 11, or the surface may be roughened. The surface of the positive electrode current collector 11 can become an interface between the positive electrode current collector 11 and the positive electrode active material layer 12 by forming the positive electrode active material layer 12 on the positive electrode current collector 11.

The positive electrode mixture 14 contains a positive electrode active material that exchanges electrons with lithium ions. The positive electrode active material is not particularly limited as long as it is a material that can reversibly release and absorb lithium ions and can transport electrons, and any known positive electrode active material that can be applied to the positive electrode of the all-solid-state lithium ion battery can be used. Examples of the positive electrode active material include composite oxides such as lithium cobalt oxide (LiCoO₂), lithium nickel oxide (LiNiO₂), lithium manganese oxide (LiMn₂O₄), a solid solution oxide (Li₂MnO₃-LiMO₂ (M=Co, Ni, and the like)), lithium-manganese-nickel-cobalt oxide (LiNiₓMn_{y}Co_{z}O₂, x+y+z=1), and olivine-type lithium phosphate oxide (LiFePO₄); conductive polymers such as polyaniline and polypyrrole; sulfides such as Li₂S, CuS, a Li—Cu—S compound, TiS₂, FeS, MoS₂, and a Li—Mo—S compound; a mixture of sulfur and carbon; and the like. The positive electrode active material may be made of only one kind of the above-mentioned materials, or may be formed of two or more kinds of the materials.

The positive electrode mixture 14 may contain a conductive additive from the viewpoint of improving the conductivity of the positive electrode 10. As the conductive additive, a conductive additive that can generally be used for all-solid-state lithium ion batteries can be used. Examples of the conductive additive include carbon black such as acetylene black and Ketjen black; carbon fiber; vapor grown carbon fiber; graphite powder; and a carbon material such as carbon nanotubes. The conductive additive may be made of only one kind of the above-mentioned materials, or may be formed of two or more kinds of the materials.

Further, the positive electrode mixture 14 may include a binder that serves to bind the positive electrode active materials to each other and to bind the positive electrode active material, the positive electrode current collector 11, and the metal body 15 to each other.

The metal body 15 is preferably a porous metal body or a metal mesh. If the metal body 15 is a porous metal body or a metal mesh, the positive electrode mixture 14 can be held within the metal body 15.

The porous metal body is a porous body of a metal containing many pores like a resin sponge. Examples of the metal material of the porous metal body include foamed aluminum, which is produced by adding a foaming agent to a molten metal, and the like.

The metal mesh is a material made of a wire woven like cloth. Examples of the metal material for the metal mesh include stainless steel, aluminum, copper, silver, gold, platinum, and the like.

In the present embodiment, the positive electrode active material layer 12 is formed on one main surface 11a of the positive electrode current collector 11, but the present invention is not limited to this. The positive electrode active material layer 12 may be formed on both main surfaces of the positive electrode current collector 11.

According to the positive electrode 10 of the present embodiment, in the positive electrode active material layer 12, the region 12A spaced apart from the current collecting portion 13 is constituted by the composite body 16 that includes the positive electrode mixture 14 and the metal body 15, and thus it is possible to suppress variations in current distribution of the positive electrode 10. Therefore, in a case where the positive electrode 10 is applied to an all-solid-state battery, deterioration of the positive electrode 10 can be suppressed.

### Second Embodiment

FIG. 2 shows a second embodiment of the positive electrode according to the embodiment of the present invention, and is a cross-sectional view in the length direction of the positive electrode.

A positive electrode 20 of the present embodiment includes a positive electrode current collector 21, a positive electrode active material layer 22 formed on one main surface 21a of the positive electrode current collector 21, and a current collecting portion 23 connected to one end surface 22a of the positive electrode active material layer 22 in a length direction.

The positive electrode active material layer 22 includes a composite body 26 that includes a positive electrode mixture 24 containing a positive electrode active material and a metal body 25. Specifically, the positive electrode active material layer 22 has a region 22A constituted by the composite body 26 and a region 22B constituted by the positive electrode mixture 24. That is, in one embodiment, the region 22B is constituted by the positive electrode mixture 24 containing the positive electrode active material, but does not contain the metal body 25.

In the present embodiment, the region 22A and the region 22B are stacked on one main surface 21a of the positive electrode current collector 21 in that order. As the distance from the current collecting portion 23 increases, the thickness of the region 22A, that is, the thickness of the composite body 26, with respect to one main surface 21a of the positive electrode current collector 21 increases. In other words, the composite body 26 (the region 22A) has an inclined portion 27 in which the thickness of the composite body 26 with respect to one main surface 21a of the positive electrode current collector 21 increases as the distance from the current collecting portion 23 increases. The inclined portion 27 has an inclined surface 27a that is inclined with respect to one main surface 21a of the positive electrode current collector 21. Further, the composite body 26 has a flat portion 28 that is connected to the inclined portion 27 and has a constant thickness with respect to one main surface 21a of the positive electrode current collector 21 in the vicinity of the current collecting portion 23.

The ratio (L11/L12) of the length of the positive electrode current collector 21 in the inclined portion 27 in the length direction (L11 shown in FIG. 2) to the length of the positive electrode current collector 21 in the flat portion 28 in the length direction (L12 shown in FIG. 2) is not particularly limited, but is preferably 30/70 to 70/30 and is more preferably 40/60 to 60/40, for example.

As the positive electrode current collector 21, the positive electrode mixture 24, and the metal body 25, the same ones as in the first embodiment can be used.

According to the positive electrode 20 of the present embodiment, the positive electrode active material layer 22 includes the composite body 26 that includes the positive electrode mixture 24 and the metal body 25, and as the distance from the current collecting portion 23 increases, the thickness of the composite body 26 with respect to the positive electrode current collector 21 increases, and thus the variations in current distribution of the positive electrode 20 can be suppressed. Therefore, in a case where the positive electrode 20 is applied to a battery (for example, an all-solid-state battery 100 which will be described below), deterioration of the positive electrode 20 can be suppressed.

### Third Embodiment

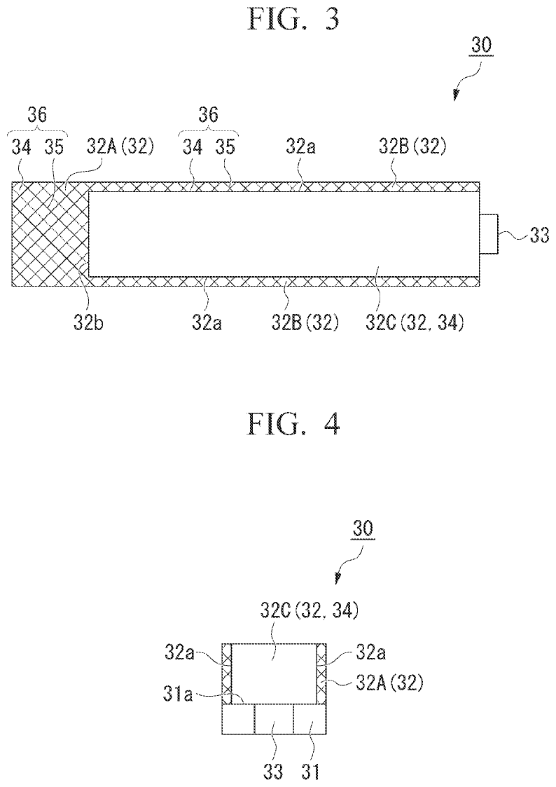

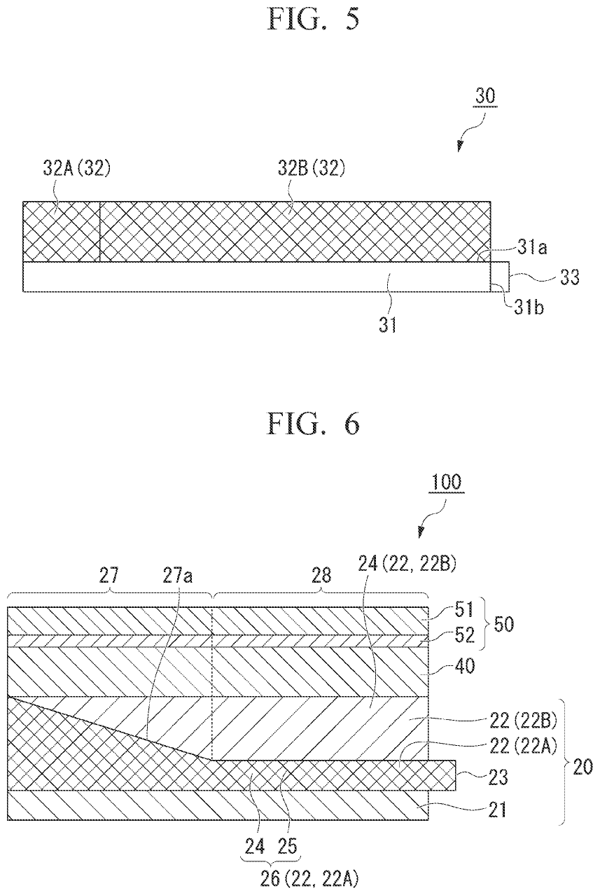

FIG. 3 is a plan view showing a third embodiment of the positive electrode according to the embodiment of the present invention. FIG. 4 is a side view showing the third embodiment of the positive electrode according to the embodiment of the present invention. FIG. 5 is a front view showing the third embodiment of the positive electrode according to the embodiment of the present invention.

A positive electrode 30 of the present embodiment includes a positive electrode current collector 31, a positive electrode active material layer 32 formed on one main surface 31a of the positive electrode current collector 31, and a current collecting portion 33 connected to one end surface 31b of the positive electrode current collector 31 in a length direction.

According to the present embodiment, in the positive electrode active material layer 32, a region 32A spaced apart from the current collecting portion 33 in the length direction of the positive electrode current collector 31 and a region 32B spaced apart from the current collecting portion 33 in a width direction of the positive electrode current collector 31 are constituted by a composite body 36 that includes a positive electrode mixture 34 containing a positive electrode active material and a metal body 35. Further, in the positive electrode active material layer 32, a region 32C near the current collecting portion 33 is constituted by the positive electrode mixture 34 containing the positive electrode active material. Specifically, in the region 32C of the positive electrode active material layer 32, two side surfaces 32a in the length direction of the positive electrode current collector 31 and one end surface 32b in the width direction of the positive electrode current collector 31 are surrounded by the composite body 36. That is, in one embodiment, the region 32C near the current collecting portion 33 is constituted by the positive electrode mixture 34 containing the positive electrode active material, but does not contain the metal body 35.

As the positive electrode current collector 31, the positive electrode mixture 34, and the metal body 35, the same ones as in the first embodiment can be used.

According to the positive electrode 30 of the present embodiment, in the positive electrode active material layer 32, the region 32A spaced apart from the current collecting portion 33 in the length direction of the positive electrode current collector 31 and the region 32B spaced apart from the current collecting portion 33 in the width direction of the positive electrode current collector 31 are constituted by the composite body 36 that includes the positive electrode mixture 34 containing the positive electrode active material and a metal body 35, and thus variations in the current distribution of the positive electrode 30 can be suppressed. Therefore, in a case where the positive electrode 30 is applied to a battery (for example, an all-solid-state battery 100 which will be described below), deterioration of the positive electrode 20 can be suppressed.

### [All-Solid-State Battery]

FIG. 6 is a cross-sectional view showing an all-solid-state battery as an example of a battery according to the embodiment of the present invention.

The all-solid-state battery 100 includes, for example, the positive electrode 20 of the second embodiment described above, a solid-state electrolyte layer 40, and a negative electrode 50. In the all-solid-state battery 100, the positive electrode 20 and the negative electrode 50 are stacked via the solid-state electrolyte layer 40.

### (Solid-State Electrolyte Layer)

The solid-state electrolyte layer 40 is disposed between the positive electrode active material layer 22 and a negative electrode active material layer 52.

The solid-state electrolyte constituting the solid-state electrolyte layer 20 is not particularly limited as long as it has lithium ion conductivity and insulation properties, and materials generally used for all-solid-state lithium ion batteries can be used. Example of the solid-state electrolyte can include inorganic solid-state electrolytes such as sulfide solid-state electrolyte materials, oxide solid-state electrolyte materials, halide solid-state electrolytes, and lithium-containing salts, polymer-based solid-state electrolytes such as polyethylene oxide, gel-based solid-state electrolytes containing lithium-containing salts and lithium ion conductive ionic liquids, and the like. Among these, sulfide solid-state electrolyte materials are preferred from the viewpoints of high conductivity of lithium ions, good structural formability by pressing, and good interfacial bonding properties.

The form of the solid-state electrolyte material is not particularly limited, but can be, for example, particulate.

The solid-state electrolyte layer 40 may contain any known nonaqueous electrolyte in lithium ion secondary batteries, electric double layer capacitors, and the like.

The solid-state electrolyte layer 40 may contain an adhesive for imparting mechanical strength and flexibility.

The solid-state electrolyte layer 40 may be in the form of a sheet having a porous substrate and a solid-state electrolyte held by the porous substrate. The form of the porous substrate is not particularly limited, but examples thereof include woven fabric, nonwoven fabric, mesh cloth, a porous membrane, an expanded sheet, a punched sheet, and the like. Among these forms, non-woven fabric is preferred from the viewpoint of handling properties that allow the filling amount of the solid-state electrolyte to be further increased.

Preferably, the porous substrate is made of an insulating material. As a result, the insulation properties of the solid-state electrolyte layer 40 can be improved. Examples of the insulating material include resin materials such as nylon, polyester, polyethylene, polypropylene, polytetrafluoroethylene, ethylene-tetrafluoroethylene copolymer, polyvinylidene fluoride, polyvinylidene chloride, polyvinyl chloride, polyurethane, vinylon, polybenzimidazole, polyimide, polyphenylene sulfite, polyether ether ketone, cellulose, and acrylic resin; natural fibers such as hemp, wood pulp, and cotton linter; glass; and the like.

### (Negative Electrode)

The negative electrode 50 includes a negative electrode current collector 51 and the negative electrode active material layer 52 formed on the negative electrode current collector 51.

Like the positive electrode current collector 11, the negative electrode current collector 51 is preferably made of at least one highly conductive material. Examples of the highly conductive material include materials with high conductivity, for example, metals containing at least one metallic element selected from silver (Ag), palladium (Pd), gold (Au), platinum (Pt), aluminum (Al), copper (Cu), chromium (Cr), and nickel (Ni), alloys such as stainless steel, or non-metals such as carbon (C). Copper, nickel, or stainless steel is preferable in consideration of manufacturing cost in addition to high conductivity. Further, stainless steel is preferable because it hardly reacts with the positive electrode active material, the negative electrode active material, and the solid-state electrolyte. For this reason, when stainless steel is used for the negative electrode current collector 51, the internal resistance of the all-solid-state battery can be reduced.

Examples of the shape of the negative electrode current collector 51 include any known shape such as a foil shape, a plate shape, a mesh shape, a nonwoven fabric shape, and a foam shape. Further, in order to improve the adhesion with the negative electrode active material layer 52, carbon and the like may be disposed on the surface of the negative electrode current collector 51, or the surface may be roughened. The surface of the negative electrode current collector 51 can become an interface between the negative electrode current collector 51 and the negative electrode active material layer 52 by forming the negative electrode active material layer 52 on the negative electrode current collector 51.

The negative electrode active material layer 52 includes a negative electrode active material that exchanges electrons with lithium ions. The negative electrode active material is not particularly limited as long as it is a material that can reversibly release and absorb lithium ions and can transport electrons, and any known negative electrode active material that can be applied to the negative electrode of the all-solid-state lithium ion battery can be used. Examples of the negative electrode active material include carbonaceous materials such as natural graphite, artificial graphite, resin charcoal, carbon fiber, activated carbon, hard carbon, and soft carbon; alloy-based materials mainly composed of tin, tin alloys, silicon, silicon alloys, gallium, gallium alloys, indium, indium alloys, aluminum, and aluminum alloys; conductive polymers such as polyacene, polyacetylene, and polypyrrole; metallic lithium; lithium alloys; and lithium-titanium composite oxides (for example, Li₄Ti₅O₁₂). The negative electrode active material may be made of only one kind of the above-mentioned materials, or may be formed of two or more kinds of the materials.

The negative electrode active material layer 52 may contain a conductive additive, a binder, and the like. These materials are not particularly limited, but for example, materials similar to those used for the positive electrode active material layer 22 described above can be used.

According to the all-solid-state battery 100 of the present embodiment, the all-solid-state battery 100 includes the positive electrode 20 of the second embodiment, and thus deterioration of the positive electrode 20 is suppressed and the life of the all-solid-state battery 100 is extended.

Although the embodiments of the present invention have been described in detail above, the present invention is not limited to the above embodiments, and various modifications and changes can be made within the gist of the present invention described in the claims.

### EXPLANATION OF REFERENCES

10, 20, 30 Positive electrode
11, 21, 31 Positive electrode current collector
12, 22, 32 Positive electrode active material layer
13, 23, 33 Current collecting portion
14, 24, 34 Positive electrode mixture
15, 25, 35 Metal body
16, 26, 36 Composite body
40 Solid-state electrolyte layer
50 Negative electrode
100 All-solid-state battery

What is claimed is:

1. A positive electrode comprising:
a positive electrode current collector;
a positive electrode active material layer formed on the positive electrode current collector; and
a current collecting portion connected to the positive electrode current collector,
wherein, in the positive electrode active material layer, a region spaced apart from the current collecting portion is constituted by a composite body that includes a positive electrode mixture containing a positive electrode active material and a metal body.

2. A positive electrode comprising:
a positive electrode current collector;
a positive electrode active material layer formed on the positive electrode current collector; and
a current collecting portion connected to the positive electrode active material layer,
wherein the positive electrode active material layer includes a composite body that includes a positive electrode mixture containing a positive electrode active material and a metal body, and is configured such that as a distance from the current collecting portion increases, a thickness of the composite body with respect to the positive electrode current collector increases.

3. The positive electrode according to claim 1, wherein the metal body is a porous metal body or a metal mesh.

4. The positive electrode according to claim 2, wherein the metal body is a porous metal body or a metal mesh.

5. A battery comprising:
the positive electrode according to claim 1;
a negative electrode in which a negative electrode active material layer is formed on a negative electrode current collector; and
an electrolyte layer that is disposed between the positive electrode and the negative electrode.

6. A battery comprising:
the positive electrode according to claim 2;
a negative electrode in which a negative electrode active material layer is formed on a negative electrode current collector; and
an electrolyte layer that is disposed between the positive electrode and the negative electrode.

7. The battery according to claim 5, which is an all-solid-state battery.

8. The battery according to claim 6, which is an all-solid-state battery.

9. A battery comprising:
the positive electrode according to claim 3;
a negative electrode in which a negative electrode active material layer is formed on a negative electrode current collector, and
an electrolyte layer that is disposed between the positive electrode and the negative electrode.

10. A battery comprising:
the positive electrode according to claim 4;
a negative electrode in which a negative electrode active material layer is formed on a negative electrode current collector, and
an electrolyte layer that is disposed between the positive electrode and the negative electrode.

11. The battery according to claim 9, which is an all-solid-state battery.

12. The battery according to claim 10, which is an all-solid-state battery.
